(19) United States
(12) Patent Application Publication
(10) Pub. No.: US 2007/0069576 A1
(43) Pub. Date: Mar. 29, 2007

(54) Valve and manufacturing method thereof

(75) Inventor: Masakuni Suzuki, Toyota-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/511,353

(22) Filed: Aug. 29, 2006

(30) Foreign Application Priority Data
Sep. 28, 2005 (JP) 2005-281199

(51) Int. Cl. B60T 8/60

(52) U.S. Cl. 303/155

(57) ABSTRACT

A valve is closed by pressing a ball portion against a seat portion so as to block a flow of a fluid and is opened by separating the ball portion from the seat portion so as to allow the fluid to flow. The valve includes a spherical base that is formed of non-magnetic metal, an intermediate layer that is formed at a surface portion of the base material by applying a tufftride process to the base material, and the outermost layer that is formed on the surface of the intermediate layer and made of diamond-like carbon (DLC).

### INCORPORATION BY REFERENCE

The disclosure of Japanese Patent Application No. 2005-281199 filed on Sep. 28, 2005, including the specification, drawings and abstract is incorporated herein by reference in its entirety.

### BACKGROUND OF THE INVENTION

1. Field of the Invention

The invention relates to a valve that is closed by pressing a ball portion against a seat portion so as to block a flow of a fluid and is opened by separating the ball portion from the seat portion so as to allow the fluid to flow, and a manufacturing method thereof.

2. Description of the Related Art

In a hydraulic auto tensioner having a check valve, a layer is formed on a surface of a check ball of the check valve using diamond-like carbon (DLC) coating and the like (as an example, refer to Japanese Patent Application Publication No. JP-A-2003-207001). The layer reduces adhesive wear between the check ball and an annular ball seat. Further, there is a technology in which a thin DLC coating is applied to a sliding surface of a sliding member of a hydraulic piston pump motor (as an example, refer to Japanese Patent Application Publication No. JP-A-2002-31040). According to another technology, a valve body includes an intermediate layer made of carbonitrided metal and the like is formed on a base made of ceramics, such as alumina, and a multilayer consisting of hard carbon layers and silicon layers is provided on a surface of the intermediate layer to cover it (as an example, refer to Japanese Patent Application Publication No. JP-A-2001-235042). Also in a solenoid valve, a valve body and a valve seat are formed of non-magnetic material treated by a certain process to increase its hardness (as an example, refer to Japanese Patent Application Publication No. JP-A-2001-263526).

In a valve including a ball portion and a seat portion, when the ball portion is pressed against the seat portion in order to block a flow of a fluid, the ball portion is placed in line contact with the seat portion, and therefore, a high contact stress acts on the contact portion. Further, as the valve is opened and closed, the ball portion slides on or collides with the seat portion. Therefore, if the valve is repeatedly opened and closed, the ball portion and the seat portion are worn out.

### SUMMARY OF THE INVENTION

An object of the invention is to provide a valve that is able to extend the lifetime of a valve by reducing wear of a ball portion and a seat portion, and a manufacturing method thereof.

A first aspect of the invention relates to a valve that is closed by pressing a ball portion against a seat portion so as to block a flow of a fluid and is opened by separating the ball portion from the seat portion so as to allow the fluid to flow. The ball portion includes: a spherical base; an intermediate layer that is formed on or at a surface portion of the base; and an outermost layer that is provided on the intermediate layer and pressed into contact with the seat portion when the valve is closed. The intermediate layer has higher adhesion to the base material than that of the outermost layer, and the outermost layer is formed as a thin layer that has lower slide resistance than that of the intermediate layer.

According to this aspect of the invention, the outermost layer of the ball portion that is pressed into contact with the seat portion when the valve is closed is formed as a thin layer and has lower slide resistance than that of the intermediate layer. Therefore, the outermost layer of the ball portion has better sliding characteristics, so wear of the ball portion and the seat portion can be reduced. Further, the intermediate layer has higher adhesion to the base material than the outermost layer. Therefore, even if the outermost layer is worn out or peeled off, the intermediate layer comes in contact with the seat portion, whereby sufficient wear resistance can be maintained. Accordingly, the lifetime of the valve can be extended.

A second aspect of the invention relates to a valve that is closed by pressing a ball portion against a seat portion so as to block a flow of a fluid and is opened by separating the ball portion from the seat portion so as to allow the fluid to flow. The ball portion includes the base made of non-magnetic metal; the intermediate layer formed on or at the surface portion of the base by applying a nitrocarburizing process to the base; and the outermost layer provided on a surface of the intermediate layer and contains diamond like carbon (DLC).

According to this aspect, the outermost layer of the ball portion, which is pressed into contact with the seat portion when the valve is closed, is made of DLC. Since the outermost layer made of DLC has better sliding characteristics than the intermediate layer and the base material, wear of the ball portion and the seat portion can be reduced. The outermost layer made of DLC is provided on the intermediate layer that is formed by applying the nitrocarburizing process to the base material made of non-magnetic metal. The intermediate layer has good adhesion to, and is harder than, the base material. Therefore, even if the outermost layer made of DLC is worn out or peeled off, the intermediate layer, which is hard, comes in contact with the seat portion, whereby sufficient wear resistance can be maintained. Accordingly, the lifetime of the valve can be extended.

The nitrocarburizing process may be a tufftride process or a gas nitrocarburizing process.

In this case, a thickness of the outermost layer may be thinner than a thickness of the intermediate layer. If the thickness of the outermost layer is made thin, peeling-off of the outermost layer is reduced, and therefore the lifetime of the valve can be extended.

The thickness of each of the intermediate layer and the outermost layer may be determined so that, in the distribution of the contact stress exerted to the ball portion when the valve is closed, the maximum stress, as seen in the direction of the depth of the ball portion, is exerted to an inner portion of the intermediate layer. In this way, the peak of the contact stress in its distribution, as seen in the direction of the depth of the ball portion may be exerted to the inner portion of the intermediate layer, which has high adhesion to the base material. Therefore, the contact stress that is exerted to the inner portion of the outermost layer becomes relatively low, reducing the possibility of the inner portion of the outermost layer being damaged and thus the possibility of peeling-off of the outermost layer that may be caused by such damage.

The seat portion may include a seat base and a solid lubricant layer that is formed on a surface of the base seat material. A lubricant film made of a fluid, such as working oil, is formed between the ball portion and the seat portion when the valve is used under normal conditions. However, the lubricant film may be destroyed by air bubbles, self-excited vibration, and the like. Therefore, by forming the solid lubricant layer on the surface of the base seat material using, for example, soft metal, seizing between the ball portion and the seat portion can be prevented even if the lubricant layer is destroyed.

A process to remove compounds that are concomitantly produced on the surface of the intermediate layer due to the nitrocarburizing process may be performed to the intermediate layer. If such a process is performed, the outermost layer that is provided on the surface of the intermediate layer can be prevented from being peeled off together with the compounds that are concomitantly produced by the nitrocarburizing process. Therefore, adhesion between the outermost layer and the intermediate layer can be improved.

A fifth aspect of the invention relates to a manufacturing method of a valve that is closed by pressing a ball portion against a seat portion so as to block a flow of a fluid and is opened by separating the ball portion from the seat portion so as to allow the fluid to flow. The manufacturing method includes the step of forming a base from non-magnetic metal; the step of forming an intermediate layer by applying a nitrocarburizing process to a surface portion of the base material; and the step of forming a layer of DLC on a surface of the intermediate layer.

Further, a process to remove compounds that are concomitantly produced on a surface of the intermediate layer due to the tufftride process may be performed after the nitrocarburizing process.

According to the invention, lifetime of a valve including a ball portion and a seat portion can be extended.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a cross-sectional view schematically showing a cross-section of a solenoid valve according to an embodiment of the invention;

FIG. 2 is a view schematically showing movement of a ball portion when the solenoid valve according to the embodiment is opened and closed;

FIG. 3 is a cross-sectional view showing the structure of the surface portion of the ball portion according to the embodiment;

FIG. 4 is a chart showing a distribution of contact stress exerted to a surface portion of the ball portion according to the embodiment in a direction of a depth of the ball portion; and

FIG. 5 is a cross-sectional view showing a cross-section of the seat portion according to the embodiment.

### DETAILED DESCRIPTION OF THE PREFERRED EMBODIMENTS

The best mode for carrying out the invention will be hereinafter described in detail with reference to the attached drawings.

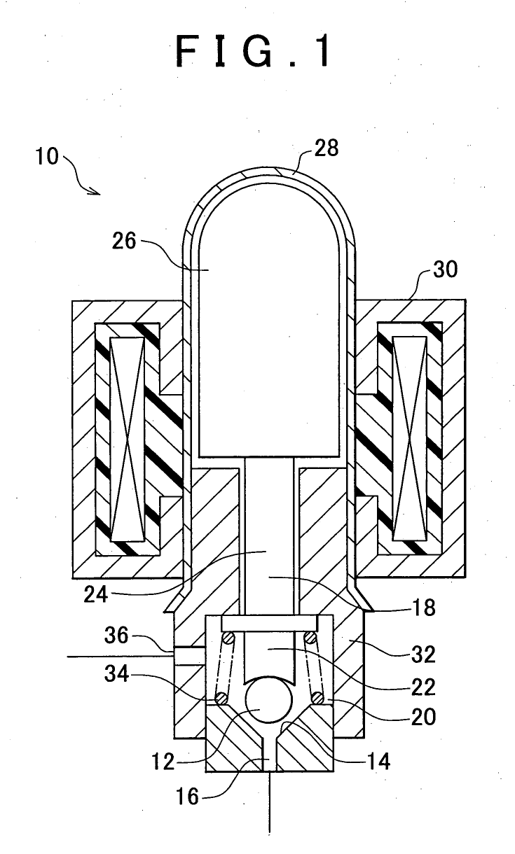

FIG. 1 is a cross-sectional view schematically showing a cross-section of a solenoid valve 10 according to an embodiment of the invention. The solenoid valve 10 according to the embodiment is used, for example, in a brake control system that controls the braking force applied to wheels of the vehicle, to control a hydraulic pressure of a working fluid supplied to wheel cylinders that are used for the application of the braking force in the vehicle.

The solenoid valve 10 includes a ball portion 12 and a seat portion 14. The ball portion 12 is formed in a spherical shape, and a diameter thereof is set to, for example, around several millimeters in the embodiment. The ball portion 12 is fixed and supported at one end of a shaft portion 18 so as to be opposite to an inlet port 16 formed at the center of the seat portion 12. In the inlet port 16, a filter (not shown) for removing foreign particles contained in a fluid which flows into the inlet port 16 is provided.

The shaft portion 18 includes a ball support portion 22 and a shaft 24. The ball support portion 22 is fixed at one end of the shaft 24, and protrudes from the shaft 24 into an interior space 20 of the solenoid valve 10. The ball portion 12 is fixed at the end of the ball support portion 22. A spring 34 is provided, in a compressed state, between the ball support portion 22 and the seat portion 14. The spring 34 urges the ball portion 12 by the spring force in the direction away from the seat portion 14. That is, in the solenoid valve 10 as shown in FIG. 1, the ball portion 12 is separated from the seat portion 14 while no current is supplied to the solenoid 30. Therefore, the solenoid valve 10 is a normally open valve.

A plunger 26 is fixed at the other end of the shaft 24. That is, the plunger 26 is fixedly, and coaxially, connected to the ball portion 12 via the shaft 24. In the periphery of the plunger 26, a sleeve 28 is provided so as to surround the plunger 26, and the solenoid 30 described above is arranged around the sleeve 28. The sleeve 28 is connected to the seat portion 14 through a fixing member 32. The shaft 24 extends through a hole formed at the center of the fixing member 32, and an outlet portion 36 through which the inner space 20 communicates with the outside is formed on a side of the fixing member 32.

When current is supplied to the solenoid 30, an electromagnetic driving force acts in such a direction as to move the plunger 26 toward the fixing member 32, that is, to move the ball portion 12 toward the seat portion 14. Then, the ball portion 12 is pressed into contact with the seat portion 14 to close the valve, whereby the fluid which flows from the inlet port 16 to the outlet port 36 is interrupted. On the other hand, when current is not supplied to the solenoid 30, the ball portion 12 is separated from the seat portion 14 by the urging force of the spring 34, so the solenoid valve 10 is opened, allowing the fluid to flow from the inlet port 16 to the outlet port 36. The solenoid valve 10 is opened and closed in this manner. Further, it is also possible to adjust an opening of the solenoid valve 10, that is, a clearance between the ball portion 12 and the seat portion 14, by adjusting the current supplied to the solenoid 30.

In the embodiment, as described above, the solenoid valve 10, which is controlled for opening and closing by the electromagnetic driving force generated when current is supplied to the solenoid 30, is used. However, the invention may be applied to a valve that uses driving forces other than the electromagnetic driving force if the valve is closed by pressing the ball portion 12 against the seat portion 14 so as to block the flow of the fluid and is opened by separating the ball portion 12 from the seat portion 14 so as to allow the fluid to flow. For example, the invention may be applied to the valve that is controlled for opening and closing by converting a rotational motion output from an electric motor into a reciprocating motion of the ball portion 12.

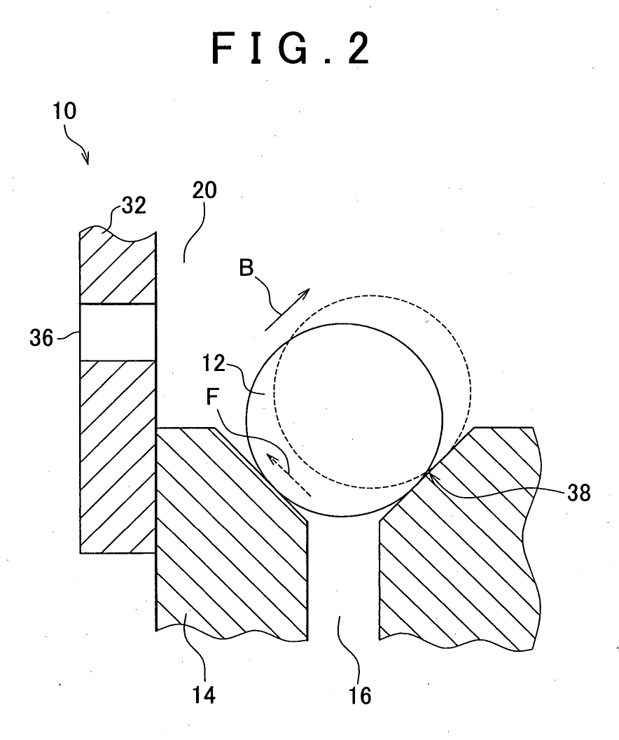

FIG. 2 is a view schematically showing a movement of the ball portion 12 caused by opening and closing the solenoid valve 10. In FIG. 2, a position of the ball portion 12 when the solenoid valve 10 is closed is shown by a solid line, and a position of the ball portion 12 when the solenoid valve 10 is opened is shown by a dashed line. It should be noted that the ball support portion 22 of the shaft portion 18, the spring 34, and the like are not shown for the purpose of simplifying the drawing.

When the current supply to the solenoid 30 is stopped and the ball portion 12 is separated from the seat portion 14, the ball portion 12 moves in the direction away from both of the inlet port 16 and the outlet port 36, as shown by an arrow B in FIG. 2. This is because the fluid in the interior space 20 flows from the inlet port 16 to the outlet port 36, as shown by a dashed arrow F in FIG. 2. Therefore, the ball portion 12 and the seat portion 14 slide on or collide with each other at a sliding friction portion 38. The sliding friction portion 38 is formed at a portion of the seat portion 14 that is in the side opposite, across the inlet portion 16, to where the outlet portion 36 is located and in the vicinity of a seal portion where the ball portion 12 is pushed against and contacts the seat portion 14 so that the flow of the fluid is blocked. The ball portion 12 is placed in line contact with the seat portion 14, and high contact stress is generated on a line contact portion of the ball portion 12. Therefore, there has been a problem that when the solenoid valve 10 is opened and closed, the ball portion 12 slides on or collides with the sliding friction portion 38, and, as a result, the ball portion 12 is quickly worn out.

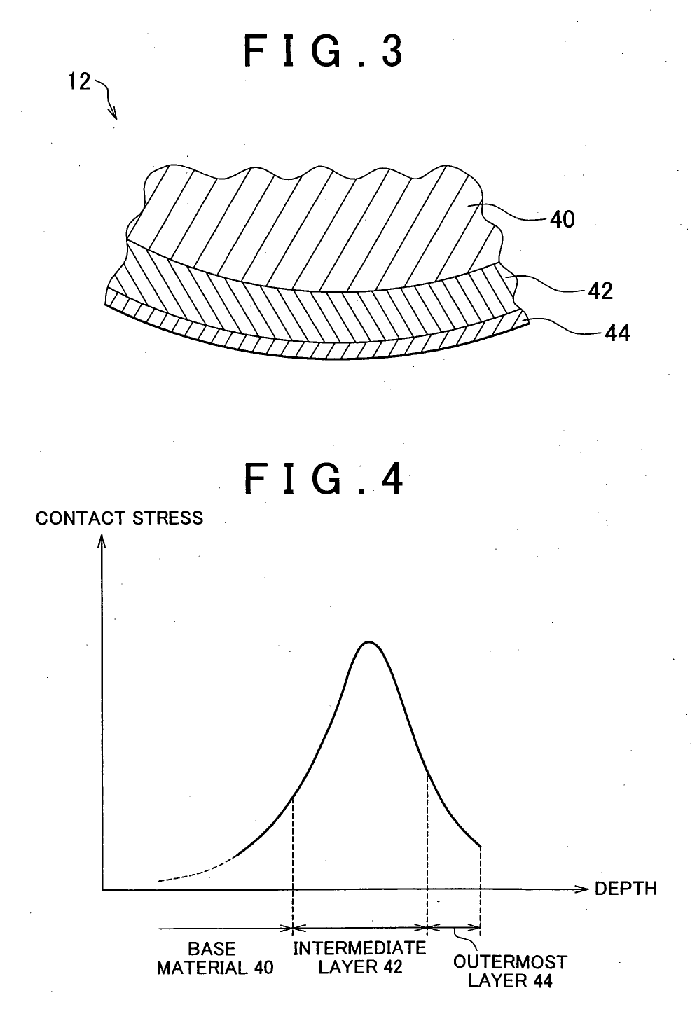

In consideration of such problem, in the embodiment, the outer portion of the ball portion 12 is formed as a layered structure as shown in FIG. 3. FIG. 3 is a cross-sectional view showing the structure of the surface portion of the ball portion 12 according to the embodiment.

The ball portion 12 includes a spherical base 40, an intermediate layer 42 that is formed on the base material 40, and the outermost layer 44 that is formed on the intermediate layer 42. The base material 40 is made of non-magnetic metal, for example, stainless steel. The base material 40 may be made of non-magnetic material in terms of preventing the ball portion 12 from attracting minute foreign particles, such as iron powder, contained in the fluid when current is supplied to the solenoid 30. Further, the base material 40 may be made of metal in terms of reducing the possibility of the base material 40 being damaged, e.g., cracked.

In the embodiment, the intermediate layer 42 is formed by applying a tufftride process (salt bath nitrocarburizing) to the surface of the base material 40. The tufftride process applied to the base material 40 creates a layer with good permeability to the base 40 on the base material 40, which is the intermediate layer 42. It should be noted, however, that gas nitrocarburizing or other nitrocarburizing methods may be used instead of the tufftride process.

The intermediate layer 42 has good adhesion to the base material 40 and is harder than the base material 40. The hardness is evaluated by, for example, a value of the Vickers hardness. The adhesion is evaluated by measuring a load applied at the moment when a crack occurs at the surface of the ball portion 12. The larger the measured load, the higher the adhesion is considered to be. A preferable measurement method of the load is, for example, a pressing method. In the pressing method, the ball portion 12 is pressed against the seat portion 14 with a predetermined load, and the load applied when the portion of the valve ball 12 where it contacts the valve seat 14 is cracked 14 is measured. In this case, the contact portion needs to be observed every time the load applied to the ball portion 12 is incremented by a predetermined value. If no crack occurs at the contact portion, the load is further increased. If a crack occurs, the load applied at the moment is taken as the evaluation value.

It should be noted, however, that a ball/disc method or a scratching method may be used instead of the aforementioned pressing method. In the ball/disc method, a disc having a certain surface roughness is rotated, and the ball portion 12 is pressed against the rotating disc. Then, the portion of the ball portion 12 where it contacts with the disc is observed every time the load applied to the ball portion 12 is incremented by a predetermined value. The load applied when a crack occurs is taken as the evaluation value. In the scratching method, load is applied to the ball portion 12 placed on a table or the like from two directions that are opposite to each other and in parallel to the surface on which the ball portion 12 is placed. Then, the ball portion 12 is scratched with a certain load along the direction that is parallel to the surface on which the ball portion 12 is placed and that is perpendicular to the direction of the load, and occurrence of a crack at the surface of the ball portion 12 is observed.

The outermost layer 44 is formed of material having low slide resistance, that is, good sliding characteristics, such as diamond-like carbon (DLC). DLC also has good wear resistance, so wear of the ball portion can be reduced and the lifetime of the solenoid valve 10 can be extended. Therefore, DLC is a preferable material in this regard. The outermost layer 44 is formed by coating DLC on the surface of the intermediate layer 42 in a coating method such as ion plating. The sliding characteristics can be evaluated by, for example, a coefficient of static friction. In the ball portion according to the embodiment, the coefficient of static friction of the outermost layer 44 is smaller than that of the intermediate layer 42. Alternatively, the sliding characteristics may be comprehensively evaluated based on the coefficient of static friction and coefficient of dynamic friction, or may further be evaluated in consideration of other factors.

A compound layer is concomitantly produced on the surface of the intermediate layer 42 due to the tufftride process for forming the intermediate layer 42. Such compound layer may be removed by performing a suitable process, for example, a primer process before forming the outermost layer 44 on the surface of the intermediate layer 42. This makes it possible to prevent the outermost layer 44 from being peeled off together with the concomitantly produced compound layer and improve the adhesion between the outermost layer 44 and the intermediate layer 42.

In the embodiment, the thickness of the outermost layer 44 is made thinner than that of the intermediate layer 42. The thickness of the intermediate 42 is set to, for example, within the range of 20 to 40 μm, and the thickness of the outermost layer 44 is set to, for example, within the range of 2 to 3 μm. By setting the thickness of the outermost layer 44 thinner as above, peeling-off of the outermost layer can be reduced.

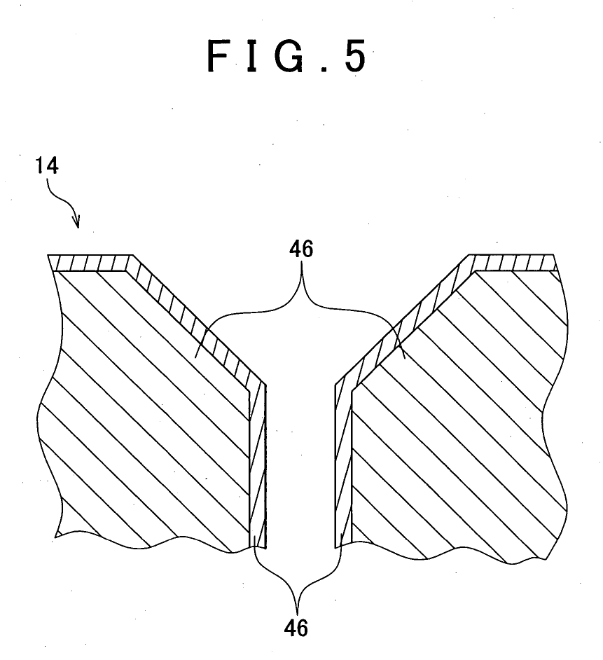

FIG. 4 is a chart showing distribution of the contact stress in the outer portion of the ball portion 12 as seen in the direction of the depth of the ball portion 12. As shown in FIG. 4, in the embodiment, the maximum contact stress, in the distribution of the contact stress in the direction of the depth of the ball portion is exerted to an inner portion of the intermediate layer 42 that has high adhesion to the base material 40. The Hertz equation, for example, may be used for setting the peak of the contact stress to the inner portion of the intermediate layer 42 in the distribution of the contact stress in the direction of the depth of the ball portion.

As described above, the contact stress exerted to the outermost layer 44 is made relatively smaller, compared to the contact stress exerted to the inner portion of the intermediate layer 42. This makes it possible to reduce the possibility of peeling-off of the outermost layer 44 from the intermediate layer 42, even if the outermost layer 44 is formed of a material that tends to come off relatively easily, such as DLC. Further, it is possible to use a material that has high hardness and good sliding characteristics for the outermost layer 44.

Further, the contact stress exerted to the base material 40 is set to be relatively lower than the contact stress exerted to the inner portion of the intermediate layer 42. Therefore, the base material 40 can be prevented from being damaged, because the intermediate layer 42 is harder than the base material 40.

FIG. 5 is a cross-sectional view showing a cross-section of the seat portion 14 in the embodiment. The seat portion 14 includes a base seat material 46 and a solid lubricant layer 48 formed on the surface of the base seat material 46. The solid lubricant layer 48 is, for example, a layer of soft metal, such as silver or lead. In the embodiment, the solid lubricant layer 48 is formed on the surface of the seat base material 46 by means of coating, such as ion plating, so as to be 1 to 2 μm in thickness, for example.

When the solenoid valve 10 is used under normal conditions, a lubricant film is formed by a fluid, such as a working fluid, between the ball portion 12 and the seat portion 14. However, the lubricant film may be destroyed for some reasons such as occurrence of air bubbles, self-excited vibration, and the like. Therefore, by forming the solid lubricant layer 48 on the surface of the base seat material 46 as described above, it is possible to prevent seizing or the like between the ball portion 12 and the seat portion 14, even if the lubricant film is destroyed. In addition, the solid lubricant layer 48 may be provided on the seat portion 14, rather than on the ball portion 12, in order to reduce the thickness of the solid lubricant layer 48, because the sliding area on the seat portion 14 is larger than the sliding area on the ball portion 12. In addition, having the solid lubricant layer 48 on the seat portion 14 minimizes the possibility that burrs are produced when the seat portion 14 is press-fit into the solenoid valve 10 during assembly.

As described above, in the embodiment, the outermost layer 44 of the ball portion 12, which is pressed into contact with the seat portion 14, is formed of DLC on the intermediate layer 42 that is formed by applying the tufftride process to the base material 40. Therefore, the outermost layer 44 has better sliding characteristics than those of the intermediate layer 42 so wear of the ball portion 12 and the seat portion 14 is reduced. The intermediate layer 42 has high adhesion to the base material 40 and high hardness, as described above. Therefore, even when the outermost layer 44 is peeled off or worn out, the intermediate layer 42 then comes in contact with the seat portion 14, whereby sufficient wear resistance can be maintained. Accordingly, the lifetime of the valve can be extended.

Further, because the wear resistance of the ball portion is improved, the contact stress that acts on the ball portion 12 can be increased. Accordingly, the solenoid valve 10 can be made smaller in size by reducing a diameter of a seal portion where the ball portion 12 is pressed into contact with the seat portion 14.

While the invention has been described with reference to exemplary embodiments thereof, it should be understood that the invention is not limited to the exemplary embodiments or constructions. While the various elements of the exemplary embodiments are shown in various combinations and constructions, which are exemplary, other combinations and constructions, including more, less or only single element, are also within the sprit and scope of the invention.

What is claimed is:

1. A valve comprising:
a seat portion; and
a ball portion that, when separated from the seat portion, allows a fluid to flow; wherein
the ball portion includes a spherical base, an intermediate layer that is formed on or at a surface portion of the base, and a thin outermost layer that is provided on the intermediate layer, and when the valve is closed, contacts the seat portion, the thin outermost layer having a lower adhesion to the base and a lower slide resistance than the intermediate layer.

2. The valve according to claim 1, wherein:
a coefficient of friction of the thin outermost layer is lower than a coefficient of friction of the intermediate layer.

3. The valve according to claim 1, wherein:
a wear resistance of the thin outermost layer is better than a wear resistance of the intermediate layer.

4. The valve according to claim 1, wherein:
the intermediate layer is formed by a tufftride process.

5. The valve according to claim 1, wherein:
a thickness of the thin outermost layer is thinner than a thickness of the intermediate layer.

6. The valve according to claim 1, wherein:
a thickness of each of the intermediate layer and the thin outermost layer is determined so that, in a distribution of contact stress exerted to the ball portion when the valve is closed, a maximum contact stress, as seen in a direction of a depth of the ball portion, is exerted to an inner portion of the intermediate layer.

7. The valve according to claim 1, wherein:
the seat portion includes a seat base and a solid lubricant layer formed on a surface of the seat base.

8. A valve comprising:
a seat portion; and
a ball portion that, when separated from the seat portion, allows a fluid to flow; wherein
the ball portion includes a spherical base made of non-magnetic metal, an intermediate layer that is formed at a surface portion of the base by applying a nitrocarburizing process thereto, and an thin outermost layer that is formed on the intermediate layer and made of diamond like carbon.

9. The valve according to claim 8, wherein:
the intermediate layer is formed by a tufftride process.

10. The valve according to claim 8, wherein:
a thickness of the thin outermost layer is thinner than a thickness of the intermediate layer.

11. The valve according to claim 8, wherein:
a thickness of each of the intermediate layer and the thin outermost layer is determined so that, in a distribution of contact stress exerted to the ball portion when the valve is closed, a maximum contact stress, as seen in a direction of a depth of the ball portion, is exerted to an inner portion of the intermediate layer.

12. The valve according to claim 8, wherein:
the seat portion includes a seat base and a solid lubricant layer formed on a surface of the seat base.

13. The valve according to claim 9, wherein:
the intermediate layer is a layer formed by a tufftride process followed by a process to remove a compound that is produced on a surface of the intermediate layer as a result of the tufftride process.

14. A manufacturing method of a valve that blocks a flow of a fluid by pressing a ball portion against a seat portion and allows the fluid to flow by separating the ball portion from the seat portion, comprising:
forming a base of the ball portion from non-magnetic metal;
forming an intermediate layer by applying a nitrocarburizing process to a surface portion of the base; and
forming a layer of diamond like carbon on a surface of the intermediate layer.

15. The manufacturing method of the valve according to claim 14, wherein:
the nitrocarburizing process is a tufftride process.

16. The manufacturing method of the valve according to claim 15, wherein:
the tufftride process is followed by a process to remove a compound that is produced on a surface of the intermediate layer as a result of the tufftride process.
